(19) United States
(12) Patent Application Publication
(10) Pub. No.: US 2018/0096370 A1
(43) Pub. Date: Apr. 5, 2018

(54) SYSTEM, METHOD AND COMPUTER PROGRAM PRODUCT FOR IDENTIFYING EVENT RESPONSE POOLS FOR EVENT DETERMINATION

(71) Applicant: International Business Machines Corporation, Armonk, NY (US)

(72) Inventors: Roger Douglas Lederman, Briarcliff Manor, NY (US); Herbert Scott McFaddin, Yorktown Heights, NY (US); Chandrasekhar Narayanaswami, Wilton, CT (US)

(21) Appl. No.: 15/282,637

(22) Filed: Sep. 30, 2016

(51) Int. Cl. G06Q 30/02

(52) U.S. Cl. CPC G06Q 30/0204

(57) ABSTRACT

A event response pool identification method, system, and computer program product, include grouping segments of customers into a plurality of groups according to a measure of a similarity between the customers in the segments of customers, measuring a strength of an impact on a plurality of events for a group of the segments of customers by analyzing sales data across a full product set, and mapping each event to the plurality of groups that exhibit a strongest strength of the impact to the event.

### CROSS REFERENCE TO RELATED APPLICATIONS

The present application is a related Application of co-pending U.S. patent application Ser. No. ______, IBM Disclosure No. YOR920161305US1 and U.S. patent application Ser. No. ______, IBM Disclosure No. YOR920161306US1, each of which was filed on Sep. 30, 2016, the entire contents of which are incorporated herein by reference.

### BACKGROUND

The present invention relates generally to an event response pool identification method, and more particularly, but not by way of limitation, to a system, method, and computer program product for grouping retail/grocery customers who exhibit similar patterns of response (e.g., buying a product).

Conventionally, detecting event(s) that have an impact on product sales is a challenge because the event does not impact all customers uniformly. That is, for smaller events, correlations do not necessarily show up in event determination when using a full population (e.g., across the country).

Conventional techniques consider similarity of patterns, e.g. a time series of purchases, but do not address the relationship of the purchases to underlying events. Other conventional techniques consider measuring an impact of promotions, but do not identify customer pools for targeting the promotions. Also, in these conventional techniques, the product of interest is known and conversions can be tracked, whereas the conventional techniques do not discover a relevant product for an event.

### SUMMARY

Thus, the inventors have considered the technical solution to the technical problem in the conventional techniques by detecting groups of similar customers to determine which groups form the customer base for a specific event.

In an exemplary embodiment, the present invention can provide a computer-implemented event response pool identification method, the method including grouping segments of customers into a plurality of groups according to a measure of a similarity between the customers in the segments of customers, measuring a strength of an impact on a plurality of events for a group of the segments of customers by analyzing sales data across a full product set, and mapping each event to the plurality of groups that exhibit a strongest strength of the impact to the event.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for an event response pool identification method 100;

FIGS. 2A-2C exemplarily depicts an embodiments of the event response pool identification method 100;

FIG. 3 exemplarily depicts a strength of an impact on events for a subset of segments of customers for a full product set of an event;

FIG. 4 exemplarily depicts a process flow to an event response module 420;

FIG. 5 depicts a cloud computing node 10 according to an embodiment of the present invention;

FIG. 6 depicts a cloud computing environment 50 according to an embodiment of the present invention; and

FIG. 7 depicts abstraction model layers according to an embodiment of the present invention.

### DETAILED DESCRIPTION

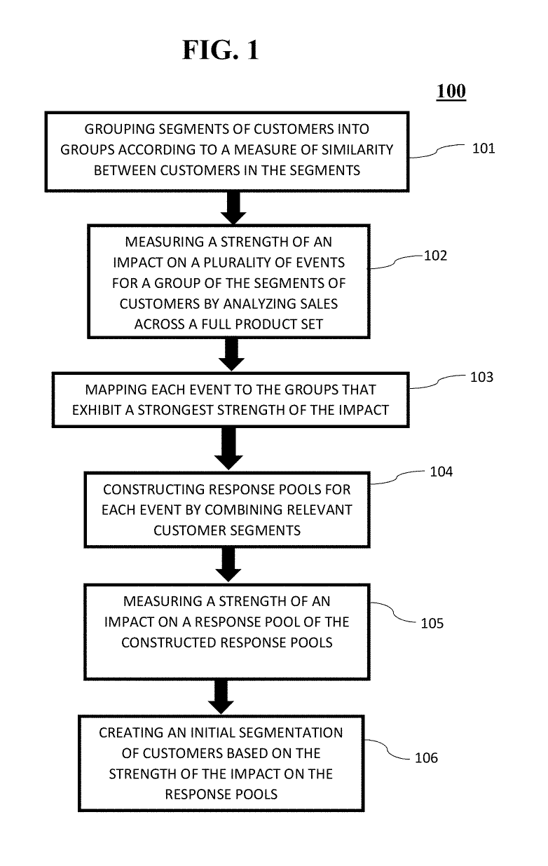

The invention will now be described with reference to FIG. 1-7, in which like reference numerals refer to like parts throughout. It is emphasized that, according to common practice, the various features of the drawing are not necessarily to scale. On the contrary, the dimensions of the various features can be arbitrarily expanded or reduced for clarity.

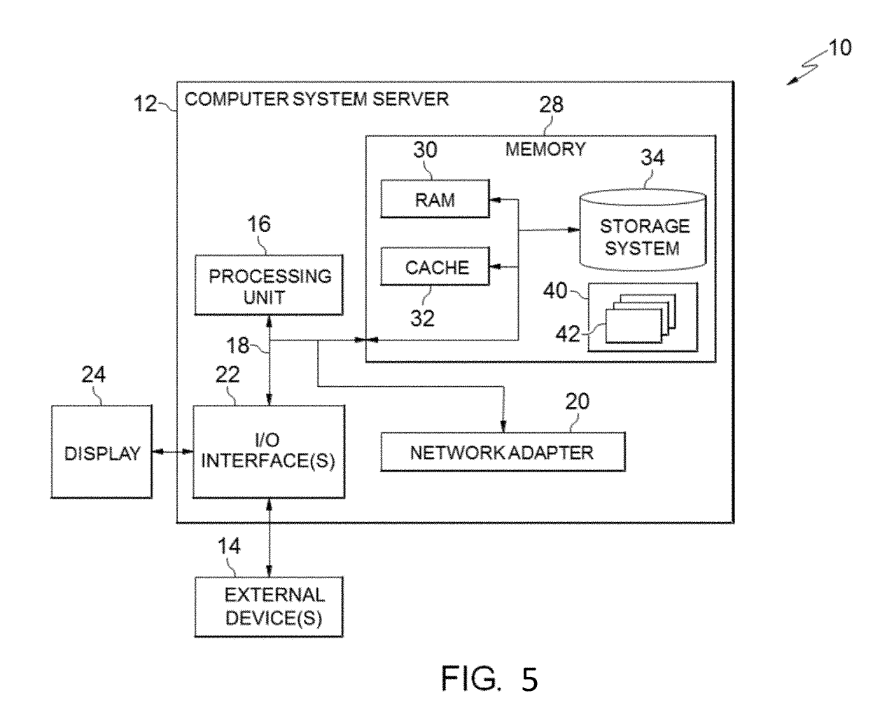

With reference now to the example depicted in FIG. 1, the event response pool identification method 100 includes various steps to measure the impact of local market events such that sellers in retail markets can use the impact to plan promotions, plan inventory, and tailor local marketing to upcoming events. Thus, for example, a large retailer may appear more local. As shown in at least FIG. 5, one or more computers of a computer system 12 according to an embodiment of the present invention can include a memory 28 having instructions stored in a storage system to perform the steps of FIG. 1.

Thus, the event response pool identification method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

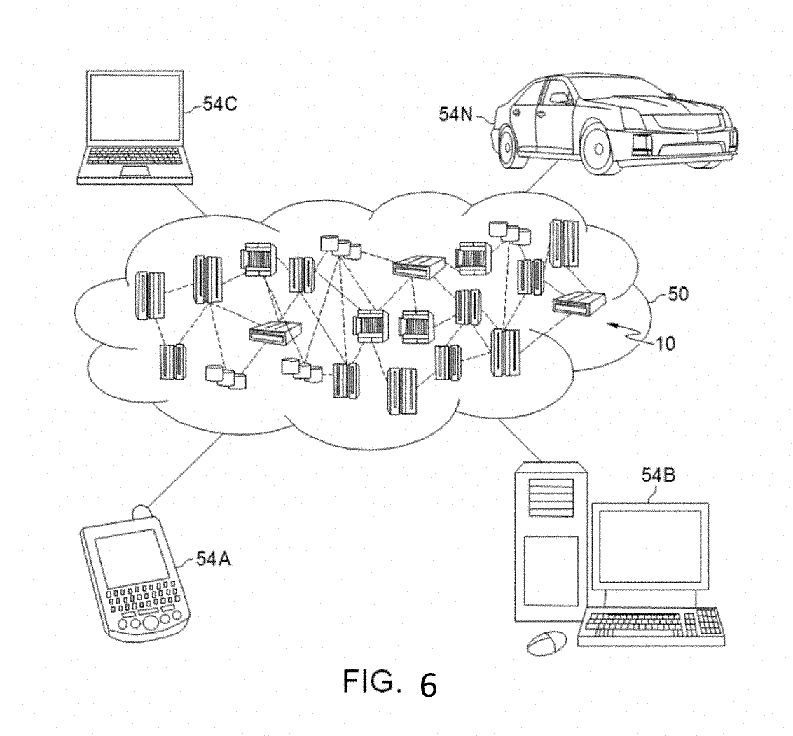

Although one or more embodiments (see e.g., FIGS. 5-7) may be implemented in a cloud environment 50 (see e.g., FIG. 6), it is nonetheless understood that the present invention can be implemented outside of the cloud environment.

In step 101, segments of customers are grouped into groups according to a measure of similarity between customers in the segments. That is, daily customer spending, customer spending by commodity, demographic characteristics of the customers, etc. are used to measure similarity between customers and group(s) according to the similarities. Thus, the segments of customers are grouped before running event correlations to isolate segments that will exhibit stronger correlations with small events.

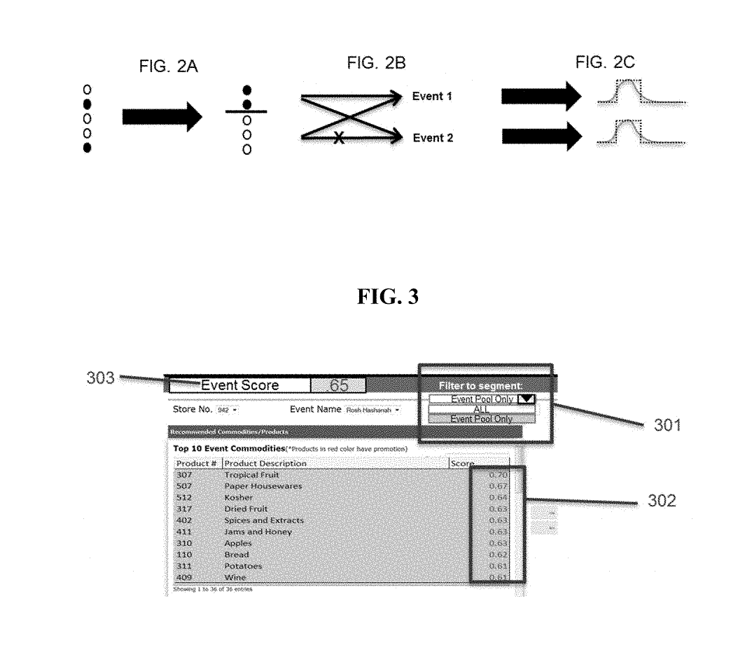

As exemplarily shown in FIG. 2A, groupings of customers with similar overall purchasing patterns can be created.

In step 102, a strength of an impact on a plurality of events for a group of the segments of customers is measured by analyzing sales across a full product set. That is, a calendar of events and event categories are used to build the plurality of events in which the sales of products is measured against the events to determine the impact strength that the group has on the sales. In other words, for each event, an event-sales correlation on the aggregation of sales of each customer group is calculated in which the customer groups with correlation greater than a threshold show the strength of the impact because the event has impacts on these customer groups. For example, the strength of the impact is measured such that customers who buy hot dogs specifically for and because of an event (i.e., 4^{th} of July, Labor Day Weekend, Sports Event, etc.) can be differentiated from customers who buy hot dogs regularly (e.g., as a matter of course).

In step 103, each event is mapped to the group of segmented customers that exhibit a strongest strength of the impact. In other words, groups of segmented customers are mapped to events with strongest correlation in segment-level testing. Thus, the customers who buy hot dogs for an event are mapped to the event such that promotion, inventory, advertising, etc. can be adjusted to target the group of customers mapped to the event.

In steps 104-105, response pools for each event are constructed by combining relevant customer grouped segments and a strength of an impact on a response pool is measured for the constructed response pools. As shown in FIG. 2C, the strength of the impact measurement on the group of customers is rerun by rerunning event correlations on relevant customers to reproduce LEMK outputs.

In step 106, an initial (pre-)segmentation of customers is created based on the strength of the impact on the response pools. The pre-segmentation can be done by guided segmentation, event-drive clustering, product driven clustering, and/or parametric segmentation.

Thereby, in step 101, the segments of customer are grouped (e.g., a static clustering) before running event correlations in steps 102 to 105 to isolate segments that will exhibit stronger correlations with small events. A “small event” may be defined as a local event confined to a particular market (e..g., local parade).

For each event, guided segmentation can be done when an expert provides a set of seed products. The segment contains customers purchasing the seeds, plus some selection of similar customers. Segments are event-specific and customers can be in multiple segments. Event-driven clustering can automatically group customers who spend during the same events (or categories of events). Event-driven clustering results in a static partition of the customer space, and event correlations are run for each event-segment combination. Segments are flagged as relevant/not relevant for each event. Product-driven clustering is similar to event-driven clustering except customers who purchase similar product sets are grouped. Parametric segmentation can leverage demographic data to create a segment membership model. Joint estimation of segment membership and product preference parameters can be attempted using parametric clustering.

In some embodiments, customer segmentation can be done based on a shopping basket. For each event, event-sales correlation can be calculated based on the aggregation of sales of each customer group. The customer groups can be selected with a correlation greater than a threshold (e.g., the event has impacts on these customer groups). The correlation analysis is rerun for a superset of customer groups and then the top commodities and products in LEMK for each event are updated (e.g., as exemplarily shown in FIG. 3). That is, as shown in FIG. 3, the user selects an event and the invention displays the overall event score and highest scoring products as indicated in 301. Box 302 depicts that the results are automatically filtered so that determination is done using the relevant event pool. Box 303 shows a strength of an impact between the group of customers and the event (e.g., 0.65).

In some embodiments, an event-driven clustering technique can be used in which static clustering (e.g., not event-specific) of customers that respond to similar events is initialized by grouping by aggregated dollar spending on days close to the events. The events are manually grouped into categories of interest (e.g. national sports events, Deer Park School events, American holidays, French holidays, etc.). For each customer of the store (e.g., with greater than five visits in a two-year history), aggregated spending on each day across all product groups is calculated. The daily spending is normalized to a percentage of customer's total spending in the two-year history. For each of n- event categories, days are flagged that are within a window of some event from the category. For each customer-category pair, a total of customer's normalized spending is computed falling on a flagged day. An n-vector of customer-category spending for each customer is taken and k-means clustering is performed on this set to group customers.

In other embodiments, a product-driven segmenting technique can be used in which static clustering (not event-specific) of customers that purchase similar product sets is first employed to group by time-aggregated dollar spending on full set of commodities. For each customer of the store (e.g., with more than five visits in two-year history), an aggregated spending on each commodity across all days is calculated. The commodity spending in normalized to a percentage of customer's total spending in the two-year history. Each customer's vector of normalized commodity spendings is used to perform k-means clustering on this set to group customers.

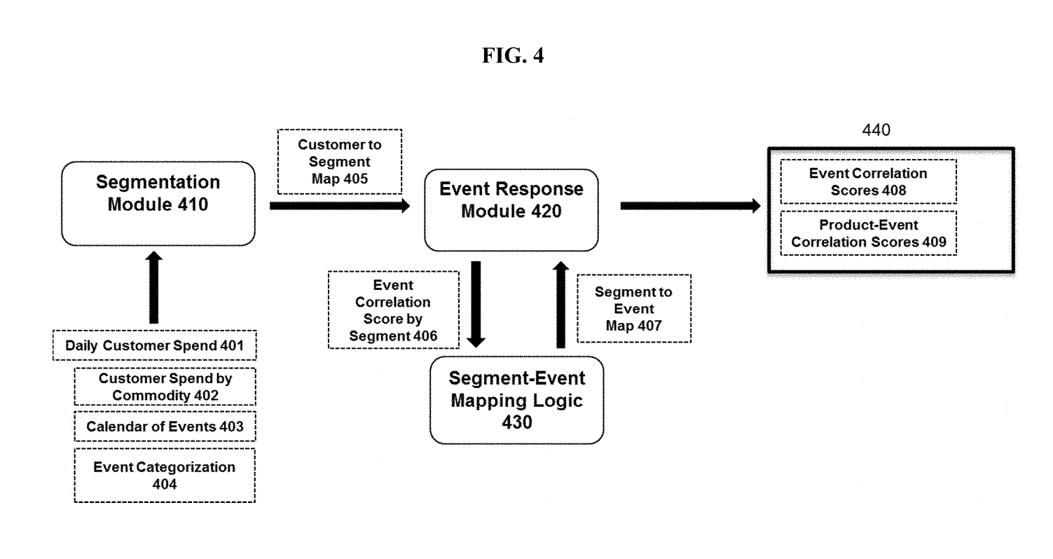

As exemplarily shown in FIG. 4, a segmentation module 410, an event response module 420, and a segment-event mapping logic 430 can output an event correlation score 408 and a product-event correlation score 409. That is, the segmentation module 410 clusters user's together based on non-specific event data such as daily customer spending 401 and customer spending by commodity 402. The strength of an impact on a plurality of events (e.g., from the calendar of events 403 and event categorization 404) for the group of the segments can be analyzed and a customer to segment map 405 that maps each event to the groups that exhibit a strongest strength of the impact is output to the event response module 420. The event response module 420 constructs an event correlation score by segment 406 and the segment-event mapping logic 430 creates an initial segmentation of the groups of customers to the events (e.g., segment to event map 407). The event response module 420 determines event correlation scores 408 and product-event correlation scores 409 from the segment to event map 407.

The method 100 can achieve a more accurate determination through a process that identifies the appropriate pool of customers within which to measure each event response. The invention can include a customer segmentation methodology or take segments as input. Generally, the finer the segment, the more reliable the determination. In either case, the method 100 can identify event response pools by first segmenting customers into homogenous groups based on some characteristic, and then determining a mapping that indicates which groups of segments form the response pool for each event of interest.

That is, an event-determination is used as a method to evaluate potential customer pools (e.g., to allow drilling down into the customer pools). Then, the resulting event relevance scores are used as a metric for evaluation of the customer grouping. Thus, the correct event response spools (e.g., the right customers) can be found). In different embodiments, the problem can be approached with search trees or approximated by a continuous relaxation from which a mapping policy is then constructed.

Thus, the invention can solve an event determination problem for moderately-sized events that are difficult to detect when studying the entire population in aggregate.

The response pool for an event refers to the optimal set of customers to analyze in order to determine the impact of the event. That is, analyzing too large of a customer set will introduce noise into the measurement because you will have customers purchasing for reasons other than the event being analyzed. In method 100, event determination is performed on a set of customers to get a score for the strength of event impact on that set. The method 100 measures the fit of each products sales trend on that customer set relative to an expected trend that depicts a ramp up towards the date of the event. The measurement is scored for each product and the top ten, twenty, etc. products scores are averaged to give an event score. The method 100 return a score based on an underlying customer set and a specified event window for some known event.

In step 101, a first segment of customers is created by some static (not event-specific) similarity metric. For each event, a score each of the segments for that event's impact determined The segments with scores exceeding a minimum threshold score “s” are taken and evaluated. For example, let S_k be the set of segments with event score greater “s” for event “k”. Then a search is performed over all combinations of segments in S_k (i.e. the power set of S_k) to find the set S′ subset of S that produces the best event score.

Note that the combination of two segments with high event scores may not score highly, since the scores for the two segments may be driven by different products and each segment will introduce noise that muddies the fit for the other segment's high scoring products. Once S′ is identified, the core of our response pool is determined, and the products that score highly in S′ are focused. Then, the segments not in S′ are inspected to see if the highest scoring products for any remaining segments matches with those in S′. Let S″ be those segments no in S′ who share a top scoring product with S′. For each segment s in S″, the score of the union (S′ U s) is evaluated and s is added to S′ if this increases the event score.

There are several degrees of freedom for the method 100. In some embodiments, “s” is an arbitrary threshold that can be tuned to allow a bigger or smaller S_k. The drawback of large S_k is computational, since the number of combinations to explore is exponential in the size of S_k. If a large S_k is chosen, it may not be possible to search the whole space of combinations, and so a heuristic can be employed. However, in some embodiments a large S_k can be chosen.

For example, an initial set can be used and then greedily add/remove individual segments that give the most improved score up to some fixed number of iterations (or when no improvements are available). Also, segments with similar top products can be clustered as pre-processing to reduce the search space. The rule for creating S″ is also flexible in some embodiments. For example, S″ can be expanded by using the top products or require multiple matches to shrink S.

In some embodiments, one need not begin the process with a segmentation. As an example, each individual (e.g., one customer) can be a segment. In some embodiments, a set of customer attributes are worked with and attempts to create membership rules that depend on the values of these attributes.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 5, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 6, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 6 are intended to be illustrative only and that computing nodes 10 and cloud computing environment 50 can communicate with any type of computerized circuit over any type of network and/or network addressable connection (e.g., using a web browser).

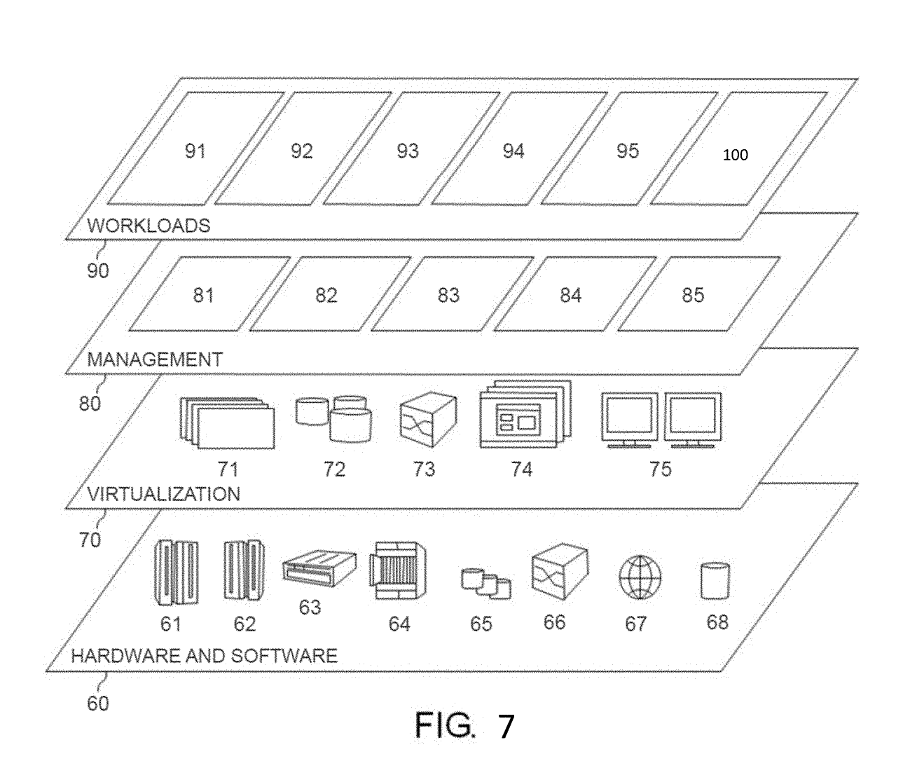

Referring now to FIG. 7, an exemplary set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the event response pool identification method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented event response pool identification method, the method comprising:
grouping segments of customers into a plurality of groups according to a measure of a similarity between the customers in the segments of customers;
measuring a strength of an impact on a plurality of events for a group of the segments of customers by analyzing sales data across a full product set; and
mapping each event to the plurality of groups that exhibit a strongest strength of the impact to the event.

2. The computer-implemented method of claim 1, further comprising:
constructing response pools for each event by combining relevant groups together; and
measuring a strength of an impact of an event on a response pool of the response pools.

3. The computer-implemented method of claim 2, further comprising creating an initial segmentation of customers for the grouping to group based on the strength of the impact of the event on the response pool.

4. The computer-implemented method of claim 1, wherein the measuring measures the strength of the impact of each group to each event to determine if the group of segments of customers is relevant to the event.

5. The computer-implemented method of claim 1, wherein the measure of the similarity to group the segments of the customers comprises customer data only.

6. The computer-implemented method of claim 5, wherein the segments of customers are re-segmented based on the plurality of groups that exhibit a strongest strength of the impact to the event by one of:
guided segmentation;
event-drive clustering;
product driven clustering; and
parametric segmentation.

7. The computer-implemented method of claim 1, embodied in a cloud-computing environment.

8. A computer program product for event response pool identification, the computer program product comprising a computer-readable storage medium having program instructions embodied therewith, the program instructions executable by a computer to cause the computer to perform:
grouping segments of customers into a plurality of groups according to a measure of a similarity between the customers in the segments of customers;
measuring a strength of an impact on a plurality of events for a group of the segments of customers by analyzing sales data across a full product set; and
mapping each event to the plurality of groups that exhibit a strongest strength of the impact to the event.

9. The computer program product of claim 8, further comprising:
constructing response pools for each event by combining relevant groups together; and
measuring a strength of an impact of an event on a response pool of the response pools.

10. The computer program product of claim 9, further comprising creating an initial segmentation of customers for the grouping to group based on the strength of the impact of the event on the response pool.

11. The computer program product of claim 8, wherein the measuring measures the strength of the impact of each group to each event to determine if the group of segments of customers is relevant to the event.

12. The computer program product of claim 8, wherein the measure of the similarity to group the segments of the customers comprises customer data only.

13. The computer program product of claim 8, wherein the segments of customers are re-segmented based on the plurality of groups that exhibit a strongest strength of the impact to the event by one of:
guided segmentation;
event-drive clustering;
product driven clustering; and
parametric segmentation.

14. An event response pool identification system, said system comprising:
a processor; and
a memory, the memory storing instructions to cause the processor to perform:
grouping segments of customers into a plurality of groups according to a measure of a similarity between the customers in the segments of customers;
measuring a strength of an impact on a plurality of events for a group of the segments of customers by analyzing sales data across a full product set; and
mapping each event to the plurality of groups that exhibit a strongest strength of the impact to the event.

15. The system of claim 14, wherein the memory further stores instructions to cause the processor to perform:
constructing response pools for each event by combining relevant groups together; and
measuring a strength of an impact of an event on a response pool of the response pools.

16. The system of claim 15, wherein the memory further stores instructions to cause the processor to perform: creating an initial segmentation of customers for the grouping to group based on the strength of the impact of the event on the response pool.

17. The system of claim 14, wherein the measuring measures the strength of the impact of each group to each event to determine if the group of segments of customers is relevant to the event.

18. The system of claim 14, wherein the measure of the similarity to group the segments of the customers comprises customer data only.

19. The system of claim 14, wherein the segments of customers are re-segmented based on the plurality of groups that exhibit a strongest strength of the impact to the event by one of:
guided segmentation;
event-drive clustering;
product driven clustering; and
parametric segmentation.

20. The system of claim 14, embodied in a cloud-computing environment.
